(19) United States
(12) Patent Application Publication
(10) Pub. No.: US 2015/0191190 A1
(43) Pub. Date: Jul. 9, 2015

(54) WHEEL ASSEMBLY FOR COOLER

(71) Applicant: Outdoor Recreation Company of America, Nashville, TN (US)

(72) Inventors: John L. RICHARDSON, Etheridge, TN (US); Trey Haley, Franklin, TN (US); James Ford, Brentwood, TN (US); William Terry, Dickson, TN (US)

(21) Appl. No.: 14/586,446

(22) Filed: Dec. 30, 2014

Related U.S. Application Data
(60) Provisional application No. 61/923,581, filed on Jan. 3, 2014.

(51) Int. Cl. B62B 3/00; B62B 5/00

(52) U.S. Cl. CPC B62B 3/005; B62B 5/00

(57) ABSTRACT

A wheel assembly is provided with a frame adapted to be removably attached to a cooler. The wheel assembly includes a frame adapted to be removably attached to a cooler; a first wheel attached to a first end of the frame and a second wheel attached to a second end of the frame; and at least one protrusion extending from the frame, wherein the protrusion is adapted to be received by a void formed in a cooler such that the wheel assembly is moveable between a first position wherein the frame is attached to the cooler and a second position wherein the frame is unattached to the cooler.

### CROSS-REFERENCE TO RELATED APPLICATIONS

The present application claims the benefit of U.S. provisional application No. 61/923,581, the entirety of which is incorporated by reference hereto.

### BACKGROUND OF THE INVENTION

1. Field of the Invention

The present invention generally relates to coolers, and more particularly, to coolers with selectively removable wheels.

### BRIEF SUMMARY OF THE INVENTION

Coolers are generally used to house and transport perishable food items or cold beverages. A cooler with wheels is useful because it allows the consumer to easily move the cooler with a simple pushing or pulling motion. Sometimes, however, the wheels become an inconvenience because the consumer does not desire independent movement of the cooler. For example, the wheels of a cooler that is loaded into the trunk of a car might undesirably move during movement of the car.

There are also instances when the consumer wants to be able to efficiently transition between a cooler with wheels to a cooler without wheels. This happens, for example, when the consumer uses the cooler on a fishing trip. The wheels are useful to move the cooler to the boat. Once placed inside the boat, however, the wheels are cumbersome. They take up extra space on the boat and may cause the cooler to roll back and forth during the fishing expedition.

Thus, it is desirable to have a collapsible, stowable, and adjustable wheel assembly for a cooler that allows for an efficient and inexpensive way for consumers to selectively remove the wheels from the cooler.

In one embodiment, a cooler with a collapsible, stowable, and adjustable wheel assembly is provided. For example, the cooler may be a roto-molded cooler. A frame of the wheel assembly is adapted to be removably attached to the cooler with a first wheel attached to a first end and a second wheel attached to a second end of the frame. The frame has at least one protrusion extending therefrom. The protrusion is adapted to be received by a void formed in the cooler such that the wheel assembly is moveable between a first position wherein the frame is attached to the cooler and a second position wherein the frame is unattached to the cooler.

In one embodiment, the wheel assembly includes a slot formed in the frame for receiving the protrusion, and the position of the protrusion relative to the void formed in the cooler is adjustable by moving the protrusion within the slot. This may be used to accommodate coolers of different sizes, for example.

In one embodiment, wheel assembly includes a locking mechanism for selectively allowing rotation of at least one of the first and second wheel between a rotation position and a stowing position. In one embodiment, the locking mechanism further has a hole formed in the frame and a pin slidably received in the hole.

In one embodiment, a wheel kit for a cooler is provided. The wheel kit includes a cooler having at least one void formed therein and a wheel assembly. The wheel assembly includes a frame adapted to be removably attached to the cooler, a first wheel attached to a first end of the frame and a second wheel attached to a second end of the frame, and at least one protrusion extending from the frame. The protrusion is adapted to be received by the void formed in the cooler such that the wheel assembly is moveable between a first position in which the frame is attached to the cooler and a second position in which the frame is unattached to the cooler. In one embodiment, the wheel kit further comprises a container for storing the wheel assembly.

### BRIEF DESCRIPTION OF THE DRAWINGS/FIGURES

FIG. 1 is a perspective view of a wheel assembly according to an embodiment of the present invention.

FIG. 2 is a side view of the wheel assembly according to an embodiment of the present invention.

FIG. 3 is a top view of the base frame of the wheel assembly according to an embodiment of the present invention.

FIG. 4 is a bottom view of a bracket of the wheel assembly according to an embodiment of the present invention.

FIG. 5 is an expanded view of first end of the base frame according to an embodiment of the present invention.

FIG. 6 is an expanded view of a second end of the base frame according to an embodiment of the present invention.

FIG. 7 is a perspective view of the wheel assembly attached to a cooler according to an embodiment of the present invention.

FIG. 8 is a partial bottom view of a cooler with voids according to an embodiment of the present invention.

FIG. 9 is a bottom view of the wheel assembly attached to the cooler according to an embodiment of the present invention.

FIG. 10 illustrates a partial rotation of the bracket with the locking pin removed according to an embodiment of the present invention.

FIG. 11 illustrates the wheel assembly in its collapsed orientation according to an embodiment of the present invention.

FIG. 12 illustrates the wheel assembly stowed in a container according to an embodiment of the present invention.

FIG. 13 is a bottom view of the base frame with brackets attached according to an embodiment of the present invention.

FIG. 14 illustrates brackets attached to the wheels according to an embodiment of the present invention.

### DETAILED DESCRIPTION OF THE INVENTION

The present invention is now described with references to the figures where like reference numbers indicate identical or functionally similar elements. While specific configurations and arrangements are discussed, it should be understood that this is done for illustrative purposes only. A person skilled in the relevant art will recognize that other configurations and arrangements can be used without departing from the spirit and scope of the invention.

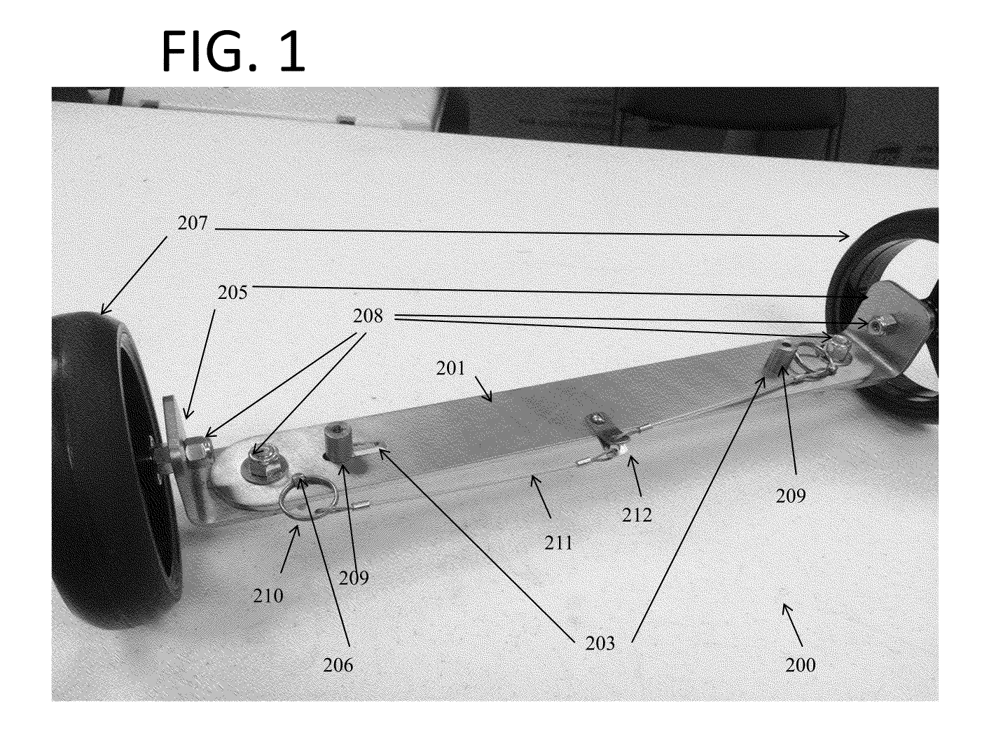

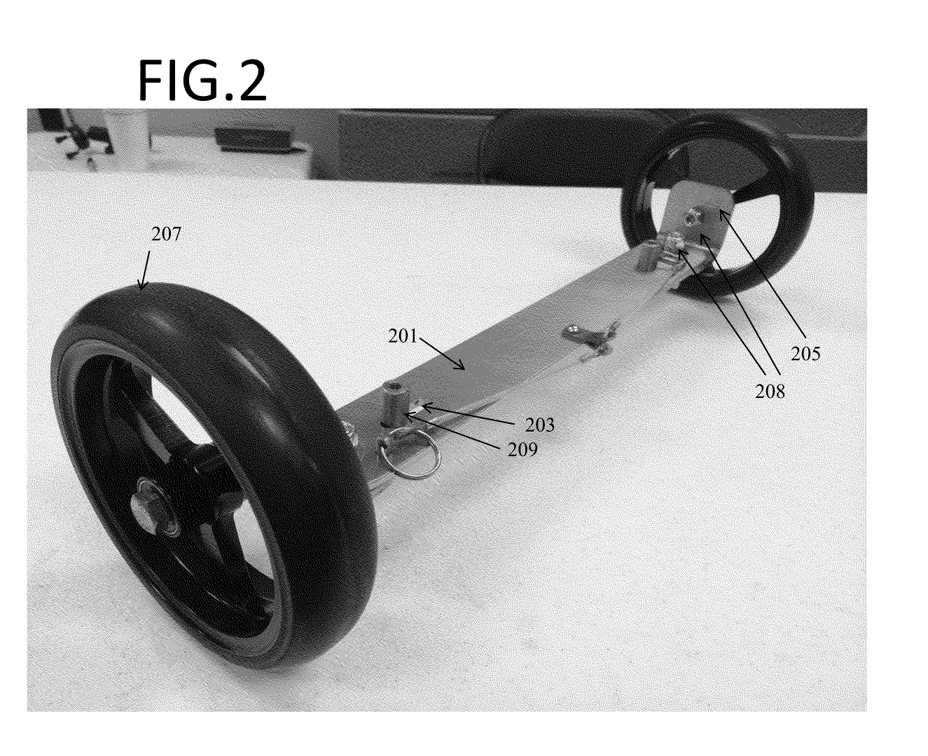

Referring to FIG. 1, a wheel assembly 200 for use with a cooler (not shown) is provided. The wheel assembly 200 is adapted to be removably attachable to the cooler such that the cooler may be efficiently provided with and without mobility, as needed.

In one embodiment, wheel assembly 200 includes a base frame 201, brackets 205, and one or more wheels 207. Wheels 207 may be attached to base frame 201 through brackets 205 and attachment means 208, as shown, for example, in FIG. 14. While attachment means 208 are depicted in the figures as a bolt, attachment means 208 can be other mechanisms well known in the art.

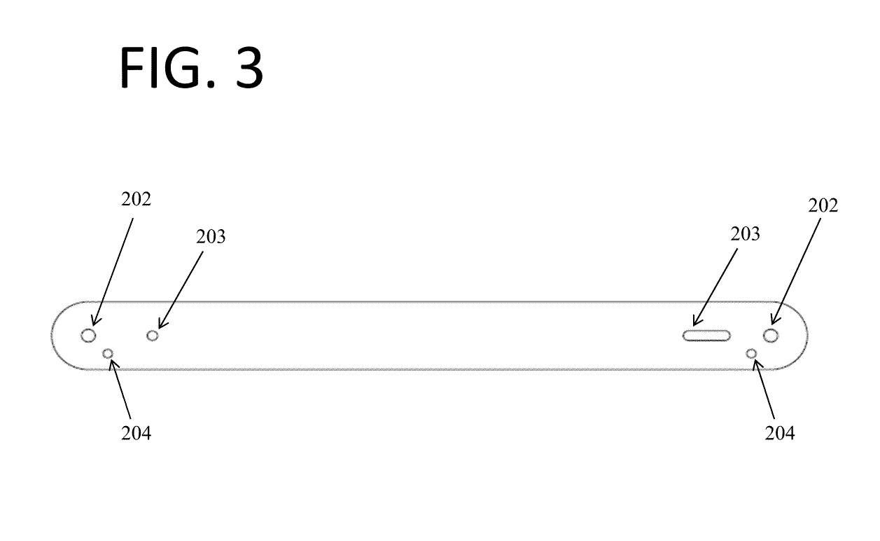

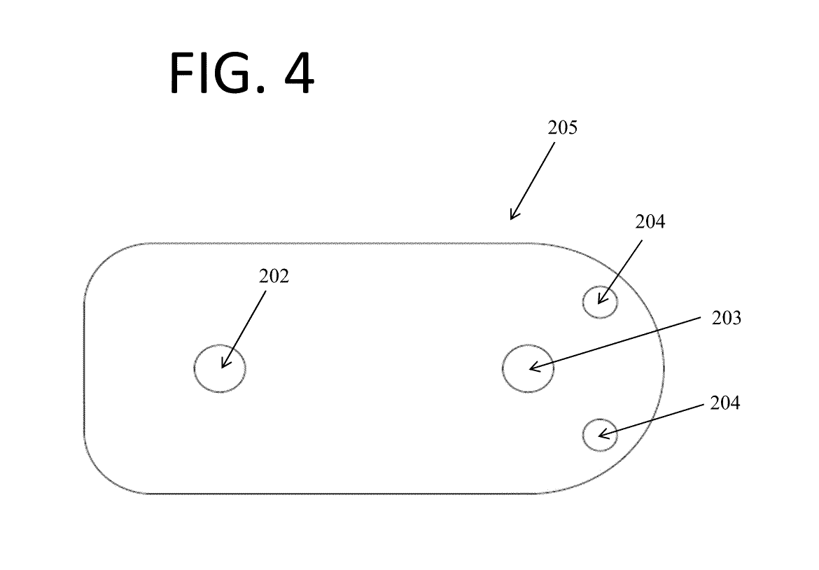

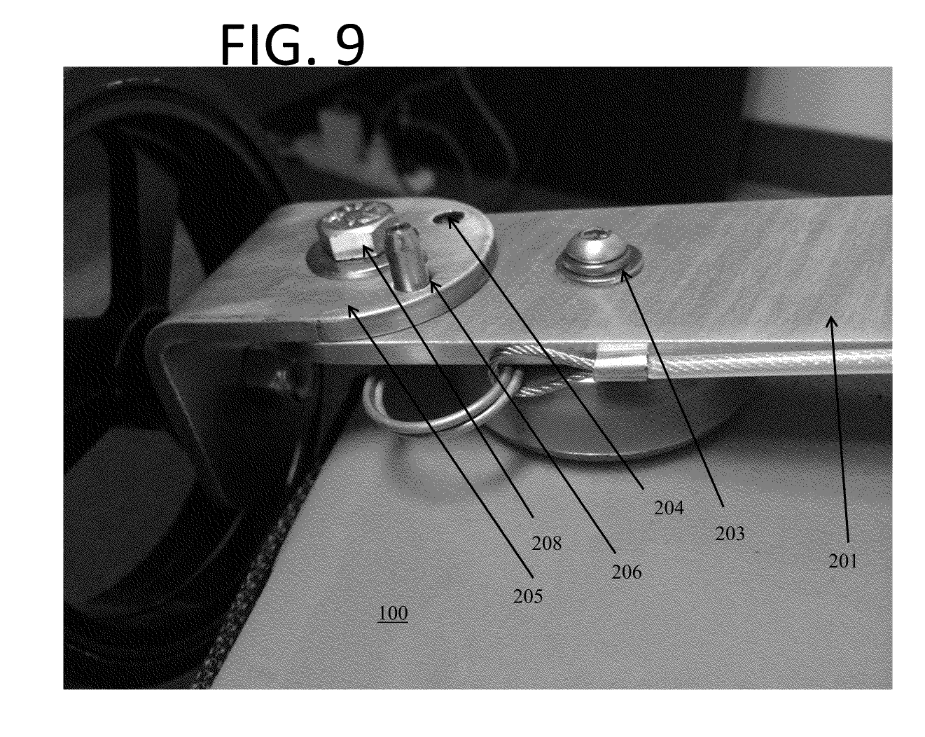

As shown in FIG. 3, in one embodiment base frame 201 includes one or more attachment holes 202, at least one protrusion slot 203, and locking pin holes 204 formed therein. Attachment holes 202 are adapted to receive attachment means 208. As shown in FIGS. 4 and 9, brackets 205 have a corresponding attachment hole 202 and a corresponding locking pin hole 204. In one embodiment, like the one shown in FIG. 4, brackets 205 also have a corresponding protrusion slot 203. In another embodiment, like the one shown in FIG. 9, brackets 205 do not have a corresponding protrusion slot 203. Attachment hole 202 on bracket 205 lines up with attachment hole 202 on base frame 201. Once the attachment holes 202 on both the bracket and the base frame line up, attachment means 208 is inserted into the holes 202 and tightened in order to attach the bracket 205 to the base frame 201. FIG. 14 shows a view of the wheels 207 with brackets 205 attached.

Referring back to FIG. 1, in one embodiment wheel assembly 200 includes two protrusions 209 extending from the base frame 201. In one embodiment, a protrusion 209 is disposed proximate to each end of the base frame 201. Protrusions 209 fit into corresponding protrusion slots 203 of the base frame 201 and embodiments of brackets 205 with protrusion slots 203.

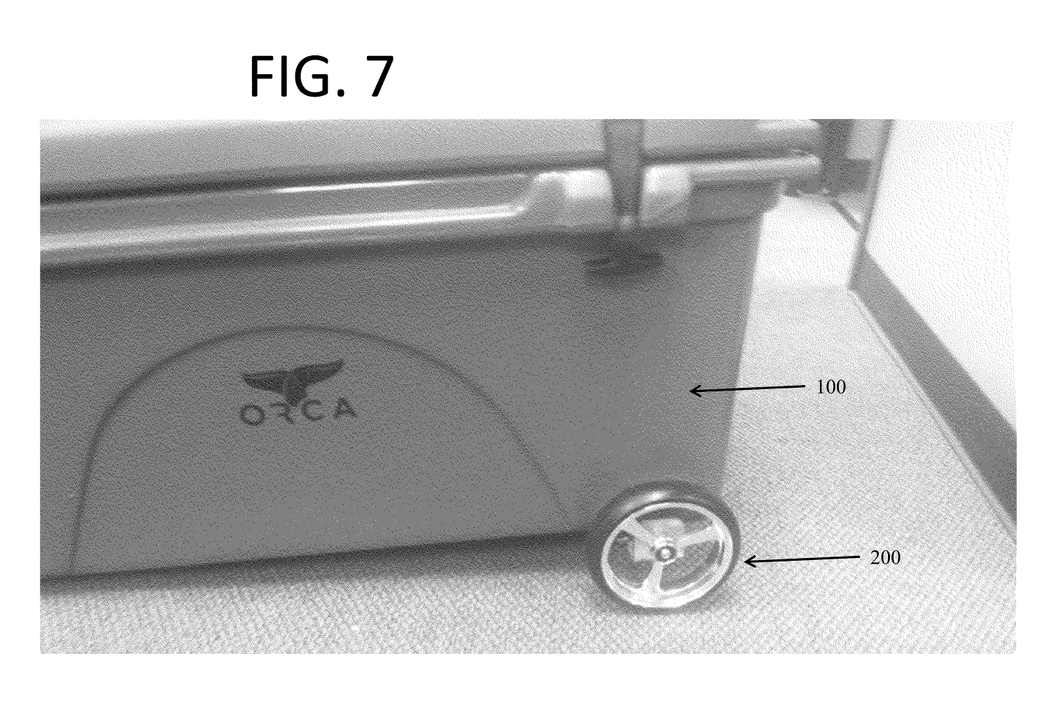

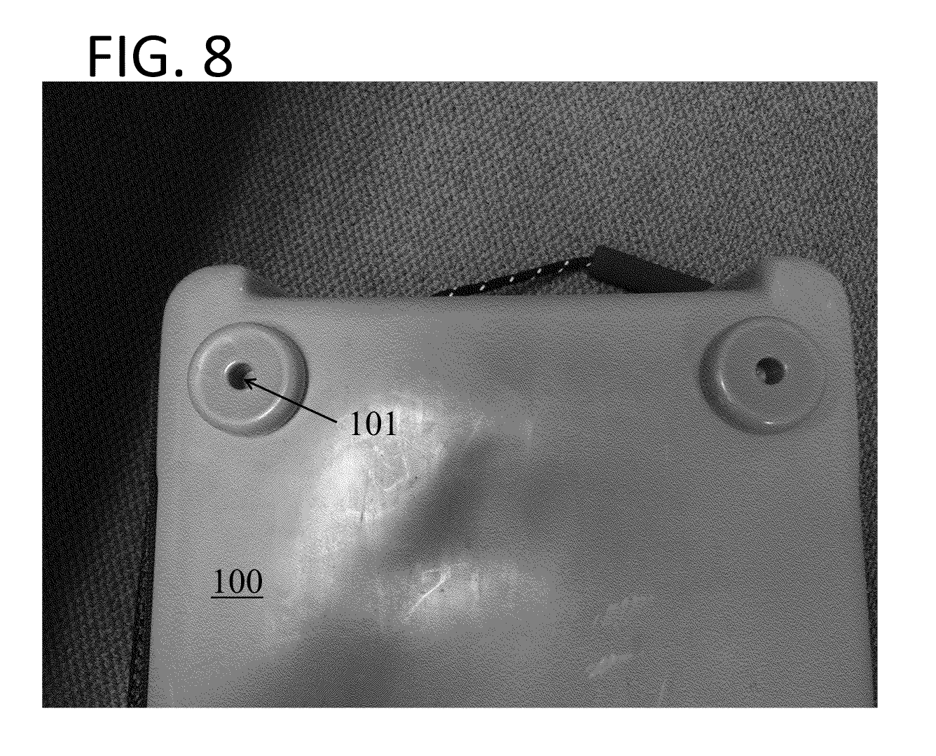

Referring to FIGS. 7, 8, and 9, protrusions 209 allow the wheel assembly 200 to be removably attached to a cooler 100 through the insertion of protrusions 209 into corresponding voids 101 located in the bottom of cooler 100 (as shown in FIG. 8). For example, cooler 100 may comprise a roto-molded cooler, which is typically manufactured having injection molded vent holes in the bottom of the cooler. In some embodiments, rubber “feet” or inserts having voids 101 may be inserted in the injection molded vent holes of the cooler. In other embodiments, cooler 100 can be any other type of cooler that includes corresponding voids 101 capable of receiving protrusions 209. Additionally, while the figures depict two protrusions 209, in another embodiment, the wheel assembly 200 only has one protrusion, the base frame only has one protrusion slot, and only one bracket has a protrusion slot. Additionally, in another embodiment, the wheel assembly has more than two protrusions, the base frame has more than two protrusion slots, and the brackets has corresponding protrusion slots. The cooler 100 may include a corresponding number of voids 101.

In one embodiment, protrusions 209 may be integrally formed with base frame 201. In other embodiments, protrusions 209 may be attached to base frame 201, e.g., screwed onto base frame 201 or attached thereto with adhesive.

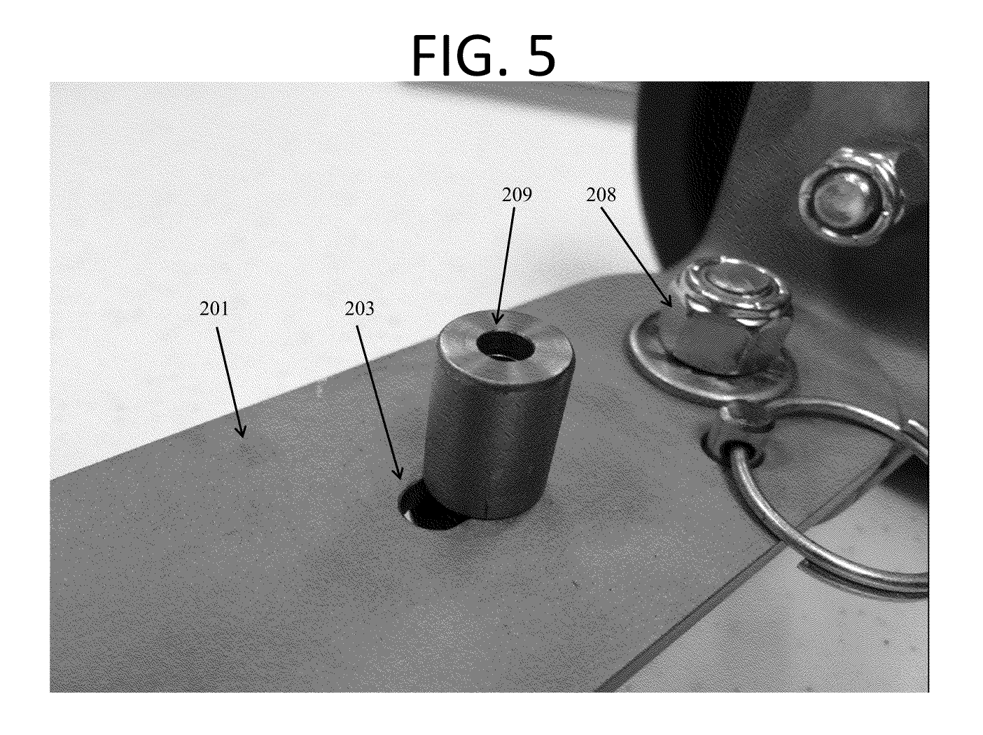

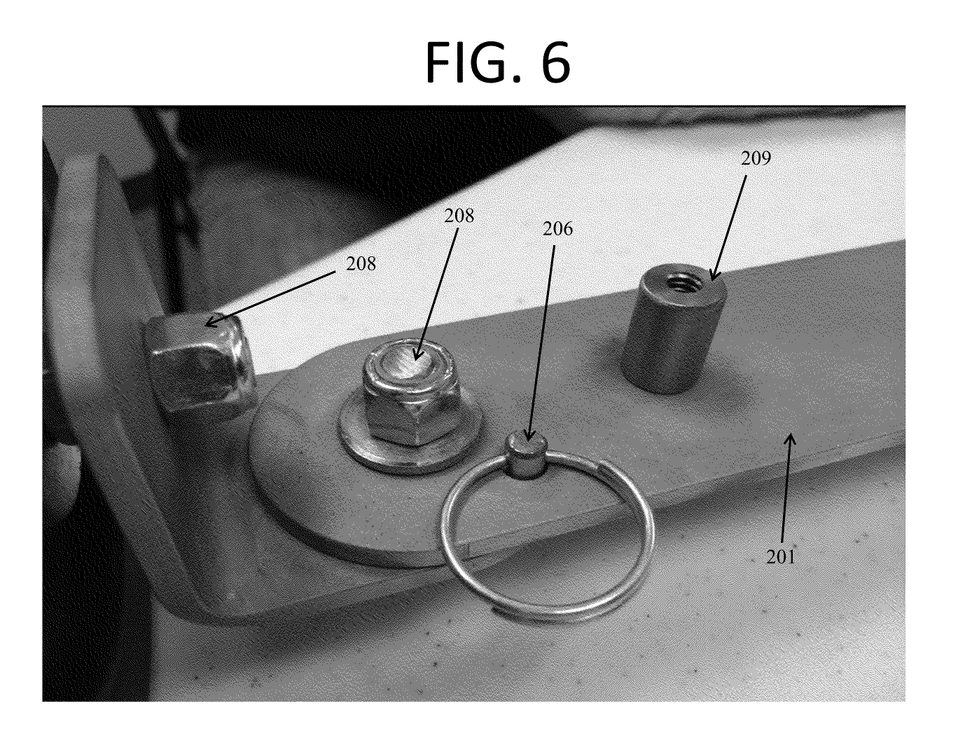

In one embodiment, protrusions 209 are also selectively moveable along the base frame 201. As shown in FIGS. 5 and 6, for example, one protrusion slot 203 located near one end of the base frame is longer than the other protrusion slot located near the other end. The longer slot allows adjustment of the location of the protrusion 209 along the base frame 201. This adjustment ability allows the wheel assembly 200 to accommodate for coolers with different void spacing. This may be useful in using wheel assembly 200 with coolers 100 of different sizes or for similar coolers with different void spacing. For example, this can occur with roto-molded coolers due to variants caused by material shrinkage during the molding processing. While the figures depict only one protrusion as being movable along the base frame, in another embodiment, both protrusions are adjustable along the length of the base frame.

When attached to the cooler, wheel assembly 200 is in a position such that the rotational axis of wheels 207 is the same direction as the longitudinal axis of the base frame. This is depicted in FIG. 1. Locking pins 206 are attached to the base frame 201 through locking ring 210, tether 211, and locking attachment means 212. In this uncollapsed position, locking pins 206 are fitted into locking pin slots 204 of bracket 205 and base frame 201 to lock the rotational position of the brackets 205 on the base frame.

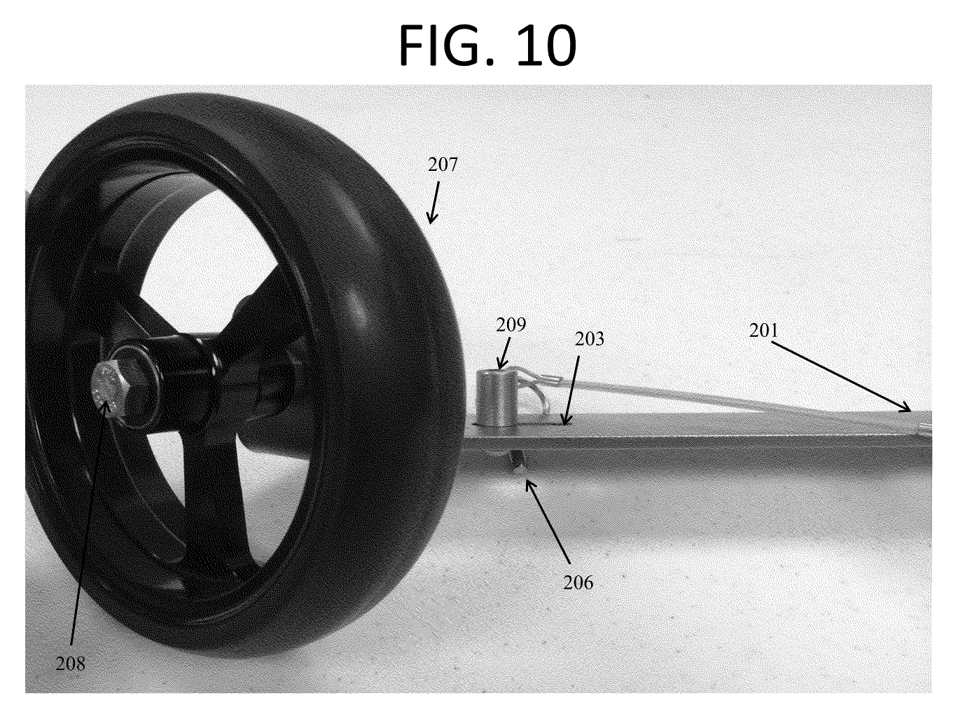

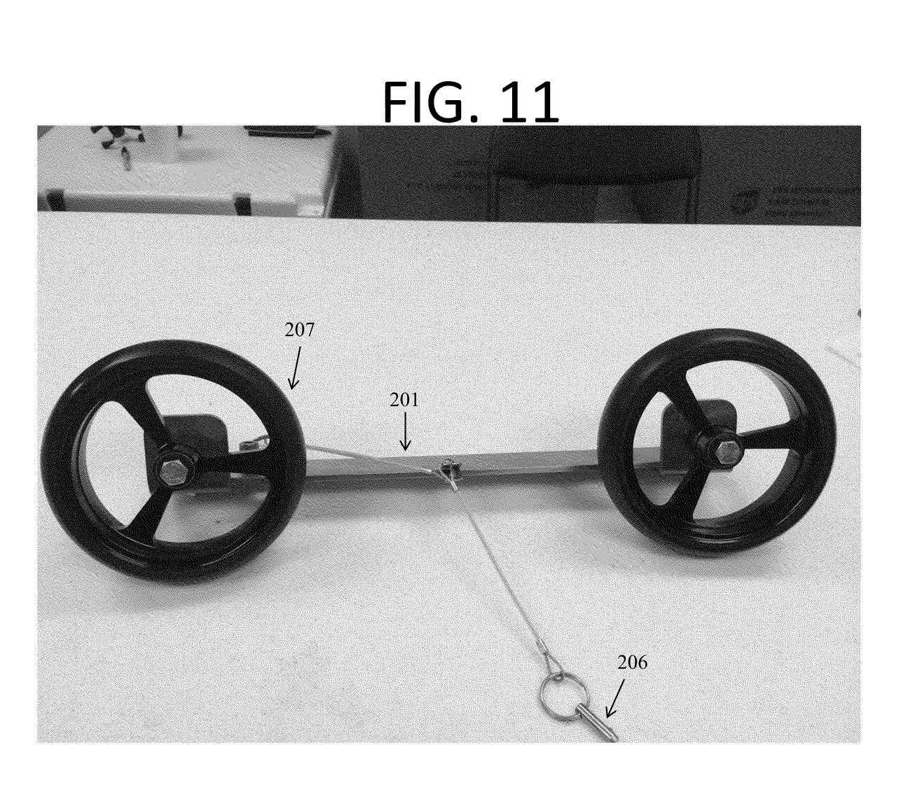

In one embodiment, wheel assembly 200 is also collapsible onto itself to allow for convenient stowage. Referring to FIGS. 10 and 11, locking pins 206 can be removed from their corresponding locking pin slots 204. This allows rotation of brackets 205 to a second position such that that the rotational axis of the wheels 207 is perpendicular to the longitudinal axis of the base frame 201. This is shown in FIG. 11. In this manner, the wheel assembly is in a collapsed orientation and is easily stowable when not in use. Because the wheel assembly 200 may be moved between operational and stowage positions without the need for additional tools in some embodiments, use of the wheel assembly 200 may be convenient and efficient.

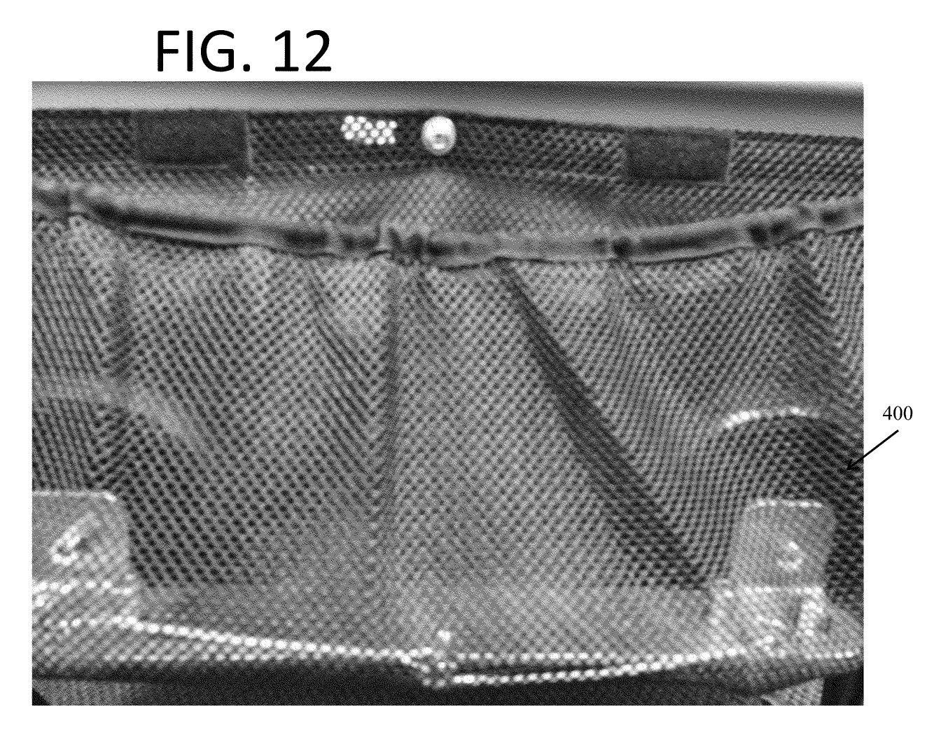

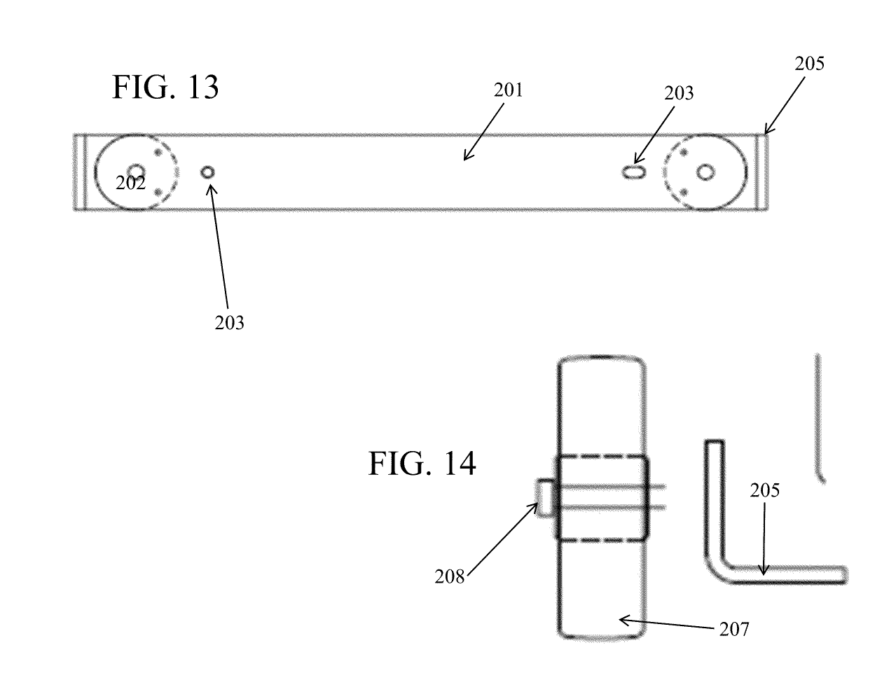

In one embodiment, a kit 300 is provided which includes a cooler 100 having at least one void in the bottom of the cooler and the previously described wheel assembly 200. In one embodiment, the kit 300 may also include a container 400 for easy storage and transportation of the wheel assembly 200 as shown in FIG. 12. While FIG. 12 depicts this container as a net, other containers are within the scope of this disclosure.

The breadth and scope of the present invention should not be limited by any of the above-described exemplary embodiments, but should be defined only in accordance with the following claims and their equivalents.

What is claimed is:

1. A wheel assembly, comprising:
a frame adapted to be removably attached to a cooler;
a first wheel attached to a first end of the frame and a second wheel attached to a second end of the frame; and
at least one protrusion extending from the frame, wherein the protrusion is adapted to be received by a void formed in a cooler such that the wheel assembly is moveable between a first position wherein the frame is attached to the cooler and a second position wherein the frame is unattached to the cooler.

2. The wheel assembly of claim 1, further comprising a slot formed in the frame for receiving the protrusion, and wherein the position of the protrusion relative to the void formed in the cooler is adjustable by moving the protrusion within the slot.

3. The wheel assembly of claim 1, further comprising a locking mechanism for selectively allowing rotation of at least one of the first and second wheel between a rotation position and a stowing position.

4. The wheel assembly of claim 3, wherein the locking mechanism comprises a hole formed in the frame and a pin slidably received in the hole.

5. A wheel kit for a cooler, comprising:
a cooler having at least one void formed therein; and
a wheel assembly, wherein the wheel assembly comprises:
a frame adapted to be removably attached to the cooler,
a first wheel attached to a first end of the frame and a second wheel attached to a second end of the frame, and
at least one protrusion extending from the frame, wherein the protrusion is adapted to be received by the void formed in the cooler such that the wheel assembly is moveable between a first position wherein the frame is attached to the cooler and a second position wherein the frame is unattached to the cooler.

6. The wheel kit of claim 5, further comprising a container for storing the wheel assembly.
